(19) United States
(12) Patent Application Publication
(10) Pub. No.: US 2021/0000146 A1
(43) Pub. Date: Jan. 7, 2021

(54) SYSTEM AND METHOD FOR FOOD STERILIZATION

(71) Applicant: SAMU TECHNOLOGY, LLC, Fremont, CA (US)

(72) Inventors: Jinqiu Zhang, Pleasanton, CA (US); Xiaobo Huang, Fremont, CA (US); Masahiro Osugi, Fremont, CA (US)

(21) Appl. No.: 16/918,623

(22) Filed: Jul. 1, 2020

Related U.S. Application Data
(60) Provisional application No. 62/921,648, filed on Jul. 1, 2019.

(51) Int. Cl. A23L 3/26; A23L 3/00

(52) U.S. Cl. CPC A23L 3/263; A23V 2002/00; A23L 3/001

(57) ABSTRACT

A system and method for food sterilization utilizing microwave-generated plasma. The plasma is used to irradiate food to destroy pathogens on the food, whereby the food is sterilized. The plasma may be a low-temperature, high-pressure plasma.

### CROSS-REFERENCE TO RELATED APPLICATION

This application claims benefit from U.S. Provisional Patent Application Ser. No. 62/921,648, filed Jul. 1, 2019, the disclosure of which is incorporated herein by reference in its entirety.

### FIELD OF THE INVENTION

The present invention relates generally to food sterilization, and more particularly to food sterilization using plasma.

### BACKGROUND

Plasma is the fourth state of matter, distinct from other states of matter (i.e., solid, liquid, and gas states) as shown in FIG. 1. The plasma state is an ionization state in which the three plasma states are solid, liquid, and gas. More particularly, plasma is the fourth state of matter, distinct from the solid, liquid and gas states of matter. In general, as temperature increases and pressure decreases, a substance passes through the four different states: (1) solid, (2) liquid, (3) gas, and (4) plasma. A plasma is a gas whose atoms have lost some or all of their electrons—it is a gas of ions and electrons. The plasma state is characterized by charge separation by ionization. Plasma are overall electrically neutral, containing balanced numbers of positive and negative charges. Plasma are electric conductors, whereas gases are insulators. The plasma is composed of positive and negative charged particles (electrons, ions, atoms, molecules, and free radicals) containing a sufficient number of charges. The substance of the base is aggregated, and the state of the plasma mainly depends on its constituent particles, particle density, and particle temperature.

Plasma is classified according to the degree of gas ionization, and can be divided into 1) completely ionized gas, 2) partially ionized gas, and 3) weakly ionized gas.

Plasma particles are classified by temperature, namely, 1) thermal equilibrium plasma and 2) non-equilibrium plasma. The thermal equilibrium plasma not only has high electron temperature, but also high heavy particle temperature, usually on the order of 104K to 2×104K. The temperature of non-equilibrium plasma electrons can be as high as 104K or more, while the temperature of heavy particles such as ions and atoms can be as low as 300K˜500K, so called low temperature plasma. FIG. 2 illustrates four kinds of plasma that are provided for various applications.

One application of plasma is food decontamination/sterilization, for example, as discussed in R. Zhou et al., “Removal of organophosphorus pesticide residues from Lycium barbarum by gas phase surface discharge plasma”, Chemical Engineering Journal, 342 (2018), 401-409, which is incorporated herein in its entirety.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the present invention provides a system for food sterilization. The system includes a housing having an inlet configured to receive a gas, an outlet configured to emit a plasma, a hollow cathode centrally positioned within the housing and extending between the inlet and outlet, and an anode disposed between the hollow cathode and the outlet. The system further includes a microwave energy generator configured to deliver microwave energy to a portion of the housing and generate the plasma, and a power source operably connected to the housing.

In another aspect, the present invention provides a method for food sterilization that includes generating a plasma using microwave energy, and irradiating food with the plasma for a predetermined time to destroy pathogens on the food, whereby the food is sterilized.

In yet another aspect, the present invention provides a food sterilization method that includes introducing a gas into an inlet of a housing that is operably connected to a microwave generator, delivering a microwave to a portion of the housing, generating a microwave plasma upon receiving the microwave, delivering the gas and microwave plasma to a hollow cathode centrally positioned within the housing and an anode surrounding an interior wall, applying power between the anode and hollow cathode, generating a hollow cathode plasma, and delivering the microwave plasma and hollow cathode plasma through an outlet of the housing as a plasma plume. The plasma plume is directed to a food surface, whereby the food is sterilized.

The invention may have one or more of the following advantages.

Food can be directly irradiated/sterilized by plasma that is generated by the system.

Food is made safer for consumption when sterilized by the system.

The system and its operation are relatively low-cost.

The system and its operation are efficient and require little time (e.g., 1 to 10 minutes) to be effective.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a schematic illustration of plasma state as the fourth state of matter.

FIG. 2 is a schematic illustration of plasma classifications.

FIG. 3 illustrates a microwave plasma system for food sterilization in accordance with an embodiment of the present invention and its usage.

FIG. 4 illustrates in greater detail the microwave plasma system shown in FIG. 3 and features thereof in accordance with an embodiment of the present invention.

FIG. 5 illustrates coliform bacteria shape and cell fluid variation, as produced by plasma irradiation of the microwave plasma system in accordance with an embodiment of the present invention.

FIG. 6 illustrates the usage of the microwave plasma system in accordance with an embodiment of the present invention.

FIG. 7 is a flowchart illustrating a method for sterilizing food in accordance with an embodiment of the present invention.

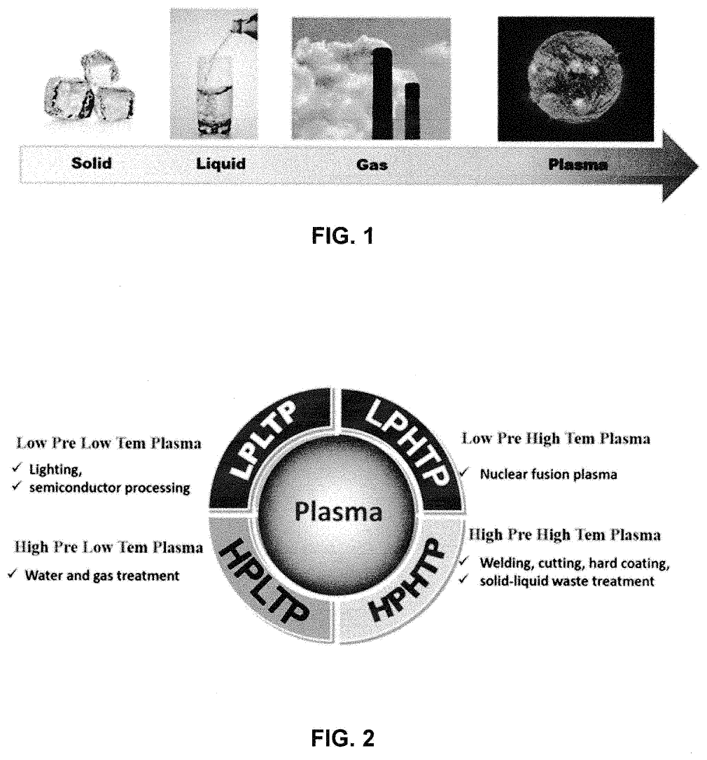

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

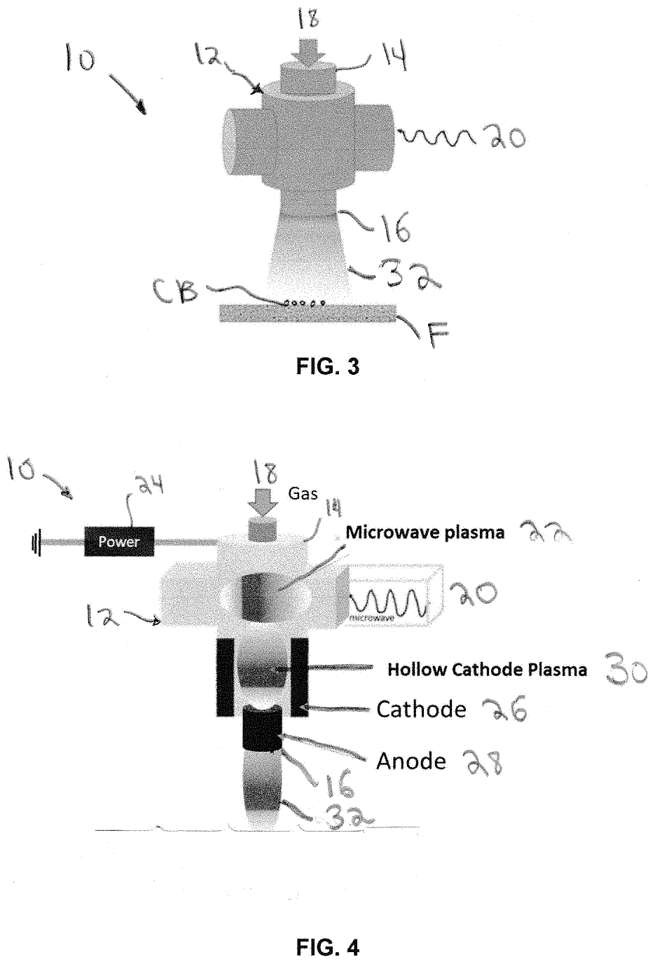

Referring to FIGS. 3 and 4, in an embodiment, a microwave plasma system 10 for food sterilization is provided. FIG. 3 is a schematic illustration of the microwave plasma system 10 in use on pathogens on a surface of a food F. Such pathogens may include, for example, bacteria (e.g., coliform bacteria CB, as illustrated in the figures) and/or viruses (e.g., HIV, hepatitis, coronavirus).

The system 10 includes a housing 12 having a gas inlet 14 and a plasma outlet 16. The gas inlet 14 is configured to receive a gas 18 that is introduced into the housing 12 and subjected to microwave energy from a microwave generator 20 that is operably connected to the housing 12 to produce a microwave plasma 22. The plasma outlet 16 is configured to emit a plasma plume 32 that includes the microwave plasma 22, as further discussed herein. In one embodiment, the microwave generator 20 delivers a microwave to the housing 12 at a frequency of 2.4 GHz, causing the gas 18 entering through the gas inlet 14 to generate the microwave plasma 22.

In an embodiment, the gas 18 is oxygen that is combined with argon.

With further reference to FIG. 4, the system 10 further includes a power source 24 that is operably connected to the housing 12. In an embodiment, the housing 12 includes a hollow cathode 26 centrally positioned therein and extending between the gas inlet 14 and plasma outlet 16, and an anode 28 disposed between the hollow cathode 26 and the plasma outlet 16. In an embodiment, the anode 28 is cylindrical, having an outer wall, an inner wall, and a bore configured to convey the plasma therethrough.

Application of power between the anode 28 and the hollow cathode 26 causes a generation of a hollow cathode plasma 30. More particularly, the power source 24 generates pulse DC power across the hollow cathode 26 and anode 28 to generate the hollow cathode plasma 30. Subsequently, a plasma plume 32 exits the plasma outlet 16, which may be directed to a surface of a food F.

In an embodiment, the system 10 is microwave plasma/hollow cathode discharge type combination system.

In various embodiments, the shape and size (e.g., length) of the plasma plume 32 can be controlled by modifying the power supplied to the hollow cathode 26 and/or the flow rate of the gas 18.

In an embodiment, the plasma plume 32 is a high-pressure plasma. In various exemplary embodiments, the pressure applied to the microwave plasma 22 and/or hollow cathode plasma 30 to produce a high-pressure plasma ranges from 100 Pa to atmospheric pressure (i.e., barometric pressure, having a mean value of 101,325 Pa at sea level).

In an embodiment, the plasma plume 32 is a low-temperature plasma. In an exemplary embodiment, the temperature applied to the microwave plasma 22 and/or hollow cathode plasma 30 is generated at a temperature of below 40° C.

In various embodiments, the low-temperature plasma is generated by a high voltage, low current and low wattage. In an embodiment, the power supply 24 applies a current of 300 mA. In an embodiment, the power supply 24 applies power in the range of less than 50 W. In an embodiment, the power supply 24 applies a voltage of about 2 kV.

In various embodiments, the plasma plume 32 is a high-pressure, low-temperature plasma.

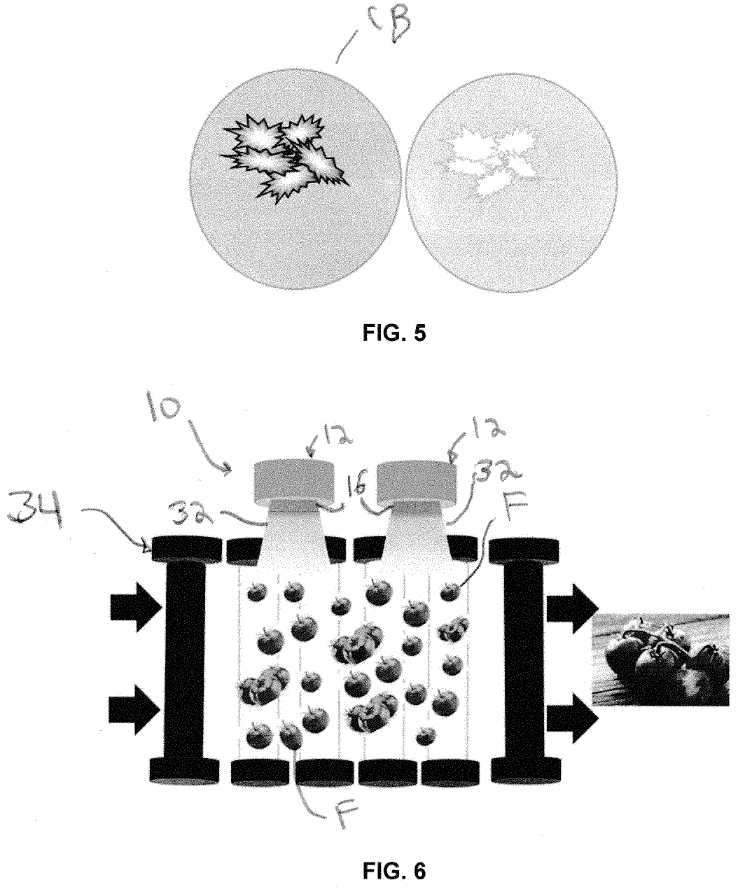

When the system 10 is used to sterilize food F (as shown schematically in FIG. 6), the plasma plume 32 irradiates the coliform bacteria CB on the surface of the food F. The plasma plume 32 irradiation causes physical and chemical damage to the coliform bacteria CB, which neutralizes and/or destroys the coliform bacteria CB. The plasma plume 32 is also effective in neutralizing and/or destroying other pathogens, such as viruses. For example, the shape and color of the coliform bacteria CB are changed by the plasma irradiation, as shown in FIG. 5. Such plasma-generated physical and chemical action damage the coliform shape and cell fluid, e.g., by denaturing proteins in the coliform bacteria.

In an embodiment, the food is subjected to the plasma plume 32 for a predetermined time of 1 minute. In another embodiment, the food F is subjected to the plasma plume 32 for a predetermined time in a range of 30 seconds to 2 minutes. In another embodiment, the food F is subjected to the plasma plume 32 for a predetermined time in a range of 2 minutes to 5 minutes. In another embodiment, the food F is subjected to the plasma plume 32 for a predetermined time in a range of 5 minutes to 7 minutes. In another embodiment, the food F is subjected to the plasma plume 32 for a predetermined time in a range of 7 minutes to 10 minutes. In another embodiment, the food F is subjected to the plasma plume 32 for a predetermined time in a range of 1 minute to 10 minutes. In another embodiment, the food F is subjected to the plasma plume 32 for a predetermined time in a range of 10 minutes to 15 minutes. In another embodiment, the food F is subjected to the plasma plume 32 for a predetermined time in a range of 15 minutes to 20 minutes.

Referring to FIG. 6, the system 10 is used to sterilize food F as part of a food processing operation in an embodiment. More particularly, the food F travels on a conveyor 34 from a first location in which the food is not exposed to the plasma plume 32 to a second location in which the food is exposed to the plasma plume 32. In the embodiment shown, the system 10 includes multiple units/housings 12, each generating their own plasma plume 32. In alternate embodiments, only one unit/housing 12 may be used.

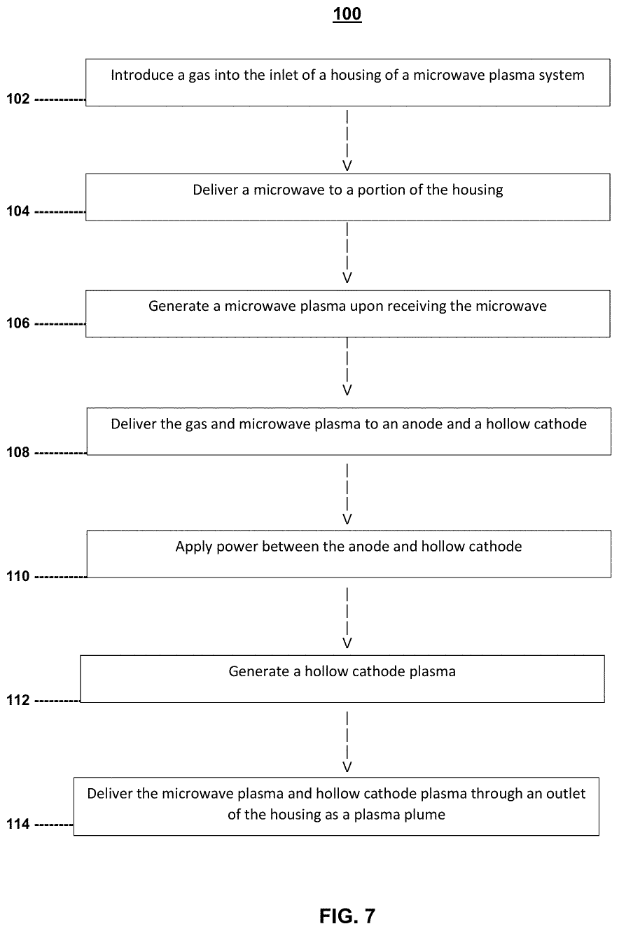

Reference is now made to FIG. 7, which shows an embodiment of a method/process 100 for food sterilization using microwave plasma that includes introducing (102) a gas into an inlet of a housing that is operably connected to a microwave generator. In one embodiment, the gas is oxygen. The oxygen may be mixed with argon.

The process 100 further includes delivering (104) a microwave to a portion of the housing.

The process 100 further includes generating (106) a microwave plasma upon receiving the microwave.

The process 100 further includes delivering (108) the gas and microwave plasma to a hollow cathode centrally positioned within the housing and an anode that is also positioned within the housing.

The process 100 further includes applying power (110) between the anode and hollow cathode, i.e., from a power source.

The process 100 further includes generating (112) a hollow cathode plasma.

The process 100 further includes delivering (114) the microwave plasma and hollow cathode plasma through an outlet of the housing, as a plasma plume.

While example embodiments have been particularly shown and described, it will be understood by those skilled in the art that various changes in form and details may be made therein without departing from the scope of the embodiments encompassed by the appended claims. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A food sterilization system comprising:
a housing having
an inlet configured to receive a gas,
an outlet configured to emit a plasma,
a hollow cathode centrally positioned within the housing and extending between the inlet and outlet,
and an anode disposed between the hollow cathode and the outlet;
a microwave energy generator configured to deliver microwave energy to a portion of the housing and generate the plasma; and
a power source operably connected to the housing.

2. The food sterilization system of claim 1, wherein the plasma is a high-pressure plasma.

3. The food sterilization system of claim 1, wherein the plasma is a low-temperature plasma.

4. The food sterilization system of claim 1, wherein the hollow cathode is a discharge type cathode.

5. The food sterilization system of claim 1, wherein the anode is cylindrical, having an outer wall, an inner wall, and a bore configured to convey the plasma therethrough.

6. The food sterilization system of claim 1, wherein the gas is oxygen.

7. A method for sterilizing food, comprising:
generating a plasma using microwave energy; and
irradiating food with the plasma for a predetermined time to destroy pathogens on the food, whereby the food is sterilized.

8. The method of claim 7, wherein the plasma generating step is performed at a high pressure so that the plasma is a high-pressure plasma.

9. The method of claim 8, wherein the high pressure ranges from 100 Pa to atmospheric pressure at sea level.

10. The method of claim 7, wherein the plasma generating step is performed at a low temperature so that the plasma is a low-temperature plasma.

11. The method of claim 10, wherein the low temperature is generated at a temperature of below 40° C.

12. The method of claim 7, wherein the predetermined time is within a range of 1 minute to 10 minutes.

13. The method of claim 7, wherein the plasma generating step is performed at a current of 300 mA.

14. The method of claim 7, wherein the plasma generating step is performed at less than 50 W.

15. The method of claim 7, wherein the plasma generating step is performed at a voltage of about 2 kV.

16. The method of claim 7, wherein the pathogens include coliform bacteria.

17. The method of claim 7, wherein the food irradiating step includes moving food from a first location in which the food is not exposed to the plasma to a second location in which the food is exposed to the plasma.

18. The method of claim 17, wherein a conveyor is used to move food from the first location to the second location.

19. A method for sterilizing food using microwave plasma, comprising:
introducing a gas into an inlet of a housing that is operably connected to a microwave generator;
delivering a microwave to a portion of the housing;
generating a microwave plasma upon receiving the microwave;
delivering the gas and microwave plasma to a hollow cathode centrally positioned within the housing and an anode disposed between the hollow cathode and an outlet of the housing;
applying power between the anode and hollow cathode;
generating a hollow cathode plasma; and
delivering the microwave plasma and hollow cathode plasma through the outlet as a plasma plume.

20. The method of claim 19, wherein the plasma delivering step includes directing the plasma plume to a food surface, whereby the food is sterilized.
